(19) United States
(12) Patent Application Publication
(10) Pub. No.: US 2012/0102503 A1
(43) Pub. Date: Apr. 26, 2012

(54) Green computing via event stream management

(75) Inventors: Erik Meijer, Mercer Island, WA (US); Dragos Manolescu, Kirkland, WA (US)

(73) Assignee: MICROSOFT CORPORATION, Redmond, WA (US)

(21) Appl. No.: 12/908,715

(22) Filed: Oct. 20, 2010

(51) Int. Cl. G06F 9/46

(52) U.S. Cl. 719/318

(57) ABSTRACT

The subject disclosure relates to resource optimization in a computing system by leveraging the asynchronous nature of event-based programming. Events arriving on respective event streams are intercepted by mechanisms as described herein that regulate the flow of events from the event stream(s) to their corresponding programs according to a desired resource usage level associated with processing of the programs. Event flow control is performed as described herein via operations on events such as buffering, queuing, desampling, aggregating, reordering. As additionally described herein, a resource usage level for a given processing entity can be determined based on considerations such as program priorities, power profiles or other resource profiles, and resource cost analysis. Further, techniques for extending input regulation as described herein to the case of load distribution among multiple processing nodes are provided.

### TECHNICAL FIELD

The subject disclosure relates to computing system management, and, more specifically, to optimizing an event-based computing system based on event stream management, e.g., via one or more of desampling, pacing, aggregating or spreading of event streams.

### BACKGROUND

As computing technology advances and computing devices become more prevalent, computer programming techniques have adapted for the wide variety of computing devices in use. For instance, program code can be generated according to various programming languages to control computing devices ranging in size and capability from relatively constrained devices such as simple embedded systems, mobile handsets, and the like, to large, high-performance computing entities such as data centers or server clusters.

Conventionally, computer program code is created with the goal of reducing computational complexity and memory requirements in order to make efficient use of the limited processing and memory resources of associated computing devices. However, this introduces additional difficulty into the programming process, and, in some cases, significant difficulty can be experienced in creating a program that makes efficient use of limited computing resources while preserving accurate operation of the algorithm(s) underlying the program. Further, while various techniques exist in the area of computer programming for reasoning about computational complexity and memory requirements and optimizing program code for such factors, these techniques do not account for other aspects of resource usage. For example, these existing techniques do not consider power consumption, which is becoming an increasingly important factor on the bill of materials, system operating costs, device battery life, and other characteristics of a computing system.

The above-described deficiencies of today's computing system and resource management techniques are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In one or more embodiments, the asynchronous nature of event-based programming is leveraged to manage computing applications independently of other programming considerations. Various techniques for computing event management are provided herein, which can be configured for the optimization of memory usage, processor usage, power consumption, and/or any other suitable aspect of computing resource usage. Accordingly, techniques for managing a computing system as provided herein provide additional versatility in resource optimization over conventional techniques for managing computing systems. Further, computing events are managed independently of an application associated with the events and/or entities processing the events, which allows the benefits of the various embodiments presented herein to be realized with less focus on the tradeoff between efficiency and correctness than existing programming processes.

In some embodiments, a computing system implements an event manager in the operating system of the computing system and/or otherwise independent of applications executing on the computing system or processing entities that execute the applications to control operation of the computing system in an event-based manner. An event stream from the environment is identified or otherwise configured, which can be composed of various applications to be performed on the computing system or other sources of tasks for the computing system. Subsequently, the event manager collects events arriving on the event stream and controls the flow of events to respective event processing entities based on resource usage (e.g., power consumption, etc.) associated with the events, among other factors. As described herein, the flow of events to a processing entity can be controlled by buffering, queuing, reordering, grouping, and/or desampling events, among other operations. For example, events corresponding to a time-sensitive application can be removed from the event stream based on the amount of time that has elapsed since the creation of the event.

In other embodiments, the flow of events to one or more processing entities is influenced by various external considerations in addition to resource usage determinations for the events. For example, a feedback loop can be implemented such that an event processor monitors its activity level and/or other operating statistics and provides this information as feedback to the event manager, which uses this feedback to adjust the nature of events that are provided to the event processor. In another example, the event manager maintains priorities of respective applications associated with the computing system and provides events to an event processor based on the priorities of the applications to which the events correspond. Priorities can be predetermined, user specified, dynamically adjusted (e.g., based on operating state feedback from the event processor), or the like.

In further embodiments, an event manager can collect events from an event stream and distribute the events across a plurality of event processors (e.g., processor cores, network nodes, etc.). Event distribution as performed in this manner mitigates performance loss associated with contention for inputs in existing computing systems. In addition, the distribution of events across multiple event processors can be adjusted to account for varying capabilities of the processors and/or changes in their operating states.

In additional embodiments, events are scheduled for provisioning to one or more processing entities at a time selected based on varying resource costs or availability. For example, event scheduling can be conducted to vary the flow of events based on battery charge level, network loading, varying power costs, etc. By scheduling events in this manner, an impact on power consumption and/or other system operating parameters can be realized. In the case of power consumption, further considerations, such as power cost, ambient temperature (e.g., which affects the amount of cooling needed in a system and its associated power usage), etc., can be considered to achieve substantially optimal power consumption.

These and other embodiments are described in more detail below.

### BRIEF DESCRIPTION OF THE DRAWINGS

Various non-limiting embodiments are further described with reference to the accompanying drawings in which:

FIG. 1 is a block diagram showing a simplified view of a computing event management system in accordance with one or more embodiments;

FIG. 2 is an illustrative overview of synchronous and asynchronous program execution;

FIG. 3 is a block diagram showing exemplary functions of a resource-aware event manager in accordance with one or more embodiments;

FIG. 4 is an illustrative view of an exemplary event scheduling or timing mechanism;

FIG. 5 is an illustrative view of resource cost data that can be leveraged by an event-based computing system;

FIG. 6 is an illustrative view of a multi-node computing system with contention-based input allocation;

FIG. 7 is an illustrative view of exemplary distribution of input events between respective computing nodes in accordance with one or more embodiments;

FIG. 8 is a block diagram showing an exemplary feedback loop that can be employed in an event-based computing system in accordance with one or more embodiments;

FIG. 9 is an illustrative view of exemplary event handling techniques in accordance with one or more embodiments;

FIG. 10 is a flow diagram illustrating an exemplary non-limiting process for managing an event-based computing system;

FIG. 11 is another flow diagram illustrating an exemplary non-limiting process for regulating the flow of activity to one or more processing nodes;

FIG. 12 is a block diagram representing exemplary non-limiting networked environments in which various embodiments described herein can be implemented; and

FIG. 13 is a block diagram representing an exemplary non-limiting computing system or operating environment in which one or more aspects of various embodiments described herein can be implemented.

### DETAILED DESCRIPTION

### Overview

By way of introduction, the operation of computing devices is controlled through the design and use of computer-executable program code (e.g., computer programs). Conventionally, a program is created with computational complexity and the memory footprint of the program in mind For instance, metrics such as big O notation and the like exist to enable programmers to reason about the computational complexity of a given computer program or algorithm, which in turn enables the development of various algorithms that are highly optimized for speed and efficiency. Additionally, as disk access is in some cases slow in relation to memory access, various programs are designed to balance the speed associated with memory access with memory requirements. For example, database applications and/or other applications in which minimal disk access is desired can be designed for a relatively high memory requirement. Similarly, programs designed for use on computing devices that have a large amount of memory can leverage the device memory to perform caching and/or other mechanisms for reducing disk access and/or increasing program speed.

However, while various mechanisms for reasoning about the speed and memory footprint of programs exist, these mechanisms do not take power consumption into consideration, which is likewise a desired consideration for efficiency, cost reduction, and the like. Further, while factors such as memory generally represent a fixed cost in a computing system (e.g., as a given amount of memory need only be purchased once), power consumption represents a variable cost that can be a substantial factor in the operating costs of a computing system over time. It can additionally be appreciated that the cost of power is expected to rise in the future due to increased demand and other factors, which will cause power consumption to become more important with time.

Conventionally, programming techniques have experienced difficulty in writing software for computing systems that limits power consumption. This difficulty is experienced with substantially all types of computing systems, such as smaller devices such as embedded systems or mobile handsets as well as large data centers and other large-scale computing systems. For example, reduced power consumption is desirable for small form factor devices such as mobile handsets to maximize battery life and for large-scale systems to reduce operating costs (e.g., associated with cooling requirements that increase with system power consumption, etc.). As the traditional metrics for optimizing programs for memory footprint and correctness already place a significant burden on the programming process, it would be desirable to implement techniques for optimizing the power consumption of a computing system without adding to this burden. In addition, it would be desirable to leverage similar techniques for alleviating the conventional difficulties associated with optimizing programs for memory or correctness.

Some existing computing systems implement various primitive mechanisms for reducing system power conservation. These mechanisms include, for example, reduction of processor clock speed, standby or hibernation modes, display brightness reduction, and the like. However, these mechanisms are typically deployed in an ad hoc manner and do not provide programming models by which these mechanisms can be leveraged within a program. Further, it is difficult to quantify the amount of power savings provided by these mechanisms, as compared to resources such as memory that provide concrete metrics for measuring performance. As a result, it is difficult to optimize a computing system for a specific power level using conventional techniques.

In an embodiment, the above-noted shortcomings of conventional programming techniques are mitigated by leveraging the asynchronous nature of event-based programming. At an abstract level, various embodiments herein produce savings in power consumption and/or other resources that are similar to that achieved via asynchronous circuits. For instance, if no input events are present at an asynchronous circuit, the circuit can be kept powered down (e.g., in contrast to a clocked system, where circuits are kept powered up continuously). In various embodiments herein, similar concepts are applied to software systems. In other embodiments, various mechanisms are utilized to pace the rate of incoming events to a software system. These mechanisms include, e.g., a feedback loop between the underlying system and the environment, application priority management, resource cost analysis, etc. These mechanisms, as well as other mechanisms that can be employed, are described in further detail herein.

In one embodiment, a computing event management system as described herein includes an event manager component configured to receive one or more events via at least one event stream associated with an environment and a resource analyzer component configured to compute a target resource usage level to be utilized by at least one event processing node with respect to respective events of the one or more events. Additionally, the event manager component provides the at least one event of the one or more events to the at least one event processing node at an order and rate determined according to the target resource usage level.

In some examples, the target resource usage level can include a power level and/or any other suitable work level(s). In another example, the resource analyzer component is further configured to identify resource costs, based on which the event manager component provides event(s) to at least one event processing node.

The system, in another example, further includes a desampling component configured to generate one or more desampled event streams at least in part by removing at least one event from one or more arriving events. In response, the event manager component provides at least one event of the desampled event stream(s) to event processing node(s). In one example, removal of respective events can be based at least in part on, e.g., elapsed time from instantiation of the respective events.

In further examples, the event manager component is further configured to provide a burst of at least two events to at least one event processing node. Additionally or alternatively, the event manager component can be further configured to distribute at least one event among a set of event processing nodes.

The system can in some cases additionally include a feedback processing component configured to receive activity level feedback from at least one event processing node and to control a rate at which events are provided to the at least one event processing node based at least in part on the activity level feedback.

In still another example, the system can additionally include a priority manager component configured to identify priorities of respective events. In such an embodiment, the event manager component can be further configured to provide at least one event to at least one event processing node according to the priorities of the respective events. In one example, the priority manager component is further configured to obtain at least one of user-specified information relating to priorities of the respective events or user-specified information relating to priorities of respective event streams. Additionally or alternatively, the priority manager component can be further configured to dynamically configure the priorities of respective events based at least in part on an operating state of at least one event processing node.

In yet another example described herein, the event manager component is further configured to identify a set of events received via at least one event stream at an irregular rate and to provide the set of events to at least one event processing node at a uniform rate. The event manager component can be additionally or alternatively configured to aggregate respective events received via at least one event stream.

In a further example, the system includes a profile manager component configured to maintain information relating to a resource usage profile of at least one event processing node. The event manager component can, in turn, leverage this resource usage profile information to provide at least one event to the at least one event processing node.

In another embodiment, a method for coordinating an event-driven computing system includes receiving one or more events associated with at least one event stream, identifying a work level to be maintained by at least one event processor with respect to the one or more events, and assigning at least one event of the one or more events to at least one event processor based on a schedule determined at least in part as a function of the work level to be maintained by the at least one event processor.

In an example, a power level and/or other suitable resource levels to be maintained by at least one event processor is identified with respect to the one or more events. In another example, assigning can be conducted at least partially by electing not to assign at least one received event and/or assigning respective events in a distributed manner across a plurality of event processors. In an additional example, the method can include receiving feedback relating to activity levels of at least one event processor, based on which at least one event can be assigned.

In an additional embodiment, a system that facilitates coordination and management of computing events includes means for identifying information relating to one or more streams of computing events, means for determining a resource usage level to be utilized by at least one event processing node in handling respective events of the one or more streams of computing events, and means for assigning at least one computing event of the one or more streams of computing events to the at least one event processing node based at least in part on the resource usage level determined by the means for determining.

Herein, an overview of some of the embodiments for achieving resource-aware program event management has been presented above. As a roadmap for what follows next, various exemplary, non-limiting embodiments and features for distributed transaction management are described in more detail. Then, some non-limiting implementations and examples are given for additional illustration, followed by representative network and computing environments in which such embodiments and/or features can be implemented.

### Green Computing Via Management of Event Streams

By way of further description, it can be appreciated that some existing computer systems are coordinated from the point of view of programs running on the system. Accordingly, performance analysis in such a system is conducted in a program-centric manner with regard to how the program interacts with its environment. However, resource usage in such systems can be optimized only through the programs that run on the system. For example, as a program is generally processed as a series of instructions, performance gains cannot be gained through desampling the program since removing instructions from the program will in some cases cause the program to produce incorrect results. Further, as noted above, it is difficult to create programs that are optimized for resources such as power consumption using conventional programming techniques.

In contrast, various embodiments provided herein place a program in the control of its environment. Accordingly, a program environment can provide the underlying program with input information, enabling the program to wait for input and to react accordingly upon receiving input. In this manner, a program can be viewed as a state machine, wherein the program receives input, performs one or more actions to process the input based on a current state of the program, and moves to another state as appropriate upon completion of processing of the input.

In an implementation such as that described above, the program expends resources (e.g., power) in response to respective inputs. Accordingly, by controlling the manner in which the environment provides input to the program (e.g., using rate control, filtering, aggregating, etc.), the resources utilized in connection with the program can be controlled with a high amount of granularity.

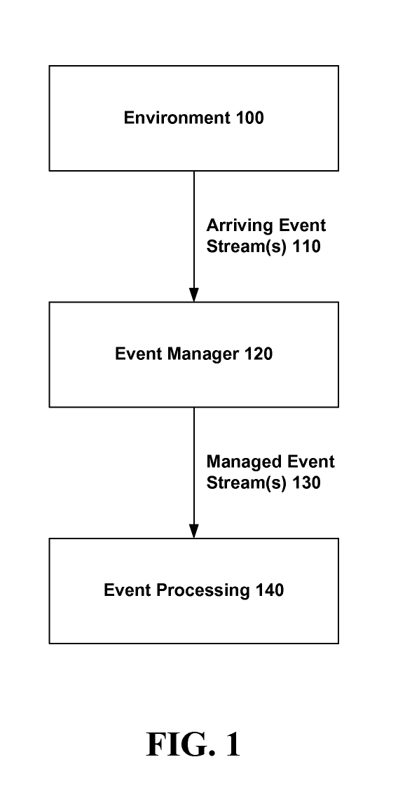

With respect to one or more non-limiting ways to conduct program input control as described above, a block diagram of an exemplary computing system is illustrated generally by FIG. 1. The computing system includes an environment 100, which provides input in the form of one or more arriving event streams 110. Further, an event processing component 140 can be configured within the computing system to implement one or more programs in an asynchronous manner. For instance, event processing component 140 can be configured to wait for input (e.g., in the form of events and/or other suitable input), and to process input as it is received in one or more pre-specified manners. Accordingly, event processing component 140 can be deactivated (e.g., powered down, etc.) when not responding to input, thereby reducing the resources utilized by the computing system.

As further shown in FIG. 1, an event manager component 120 intercepts the arriving event stream(s) 110 from environment 100 and processes respective events of the arriving event stream(s) 110 to generate one or more managed event streams 130, which are subsequently provided to event processing component 140. As described herein, event manager component 120 can implement one or more techniques for regulating the flow of events to event processing component 140 in order to achieve a desired level of resource usage. For example, event manager component 120 can limit the flow of events to event processing component 140, buffer or queue events, reorder events, aggregate events, and/or perform other suitable operations to enhance the resource usage efficiency of event processing component 140.

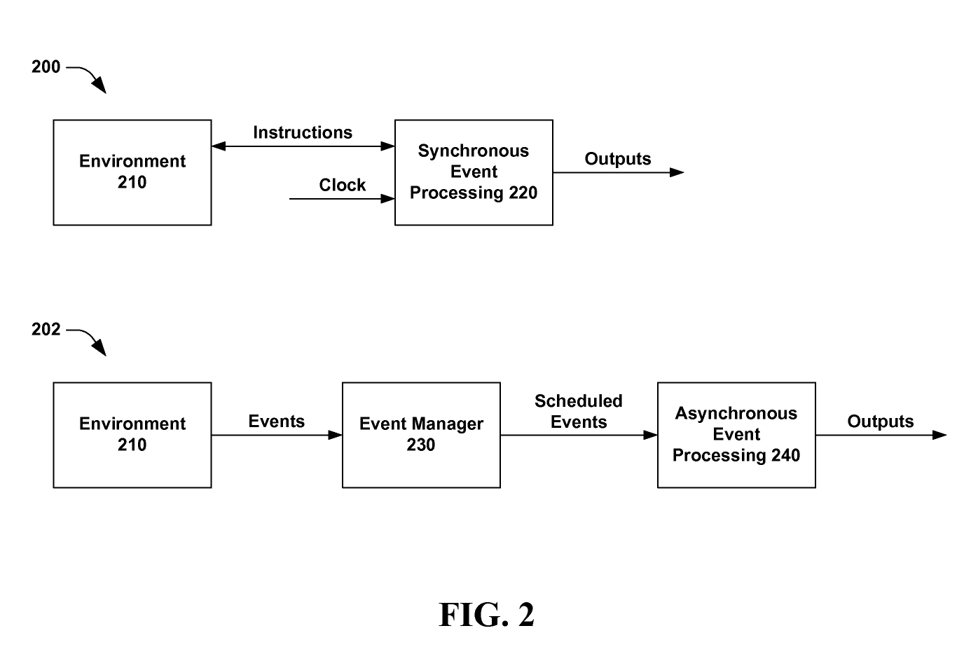

In an embodiment, the event-based computing system illustrated by FIG. 1 can differ in operation from a conventional synchronous computing system in order to provide additional benefits over those achievable by synchronous computing systems. For example, as shown by block diagram 200 in FIG. 2, a synchronous event processing component 220 can operate in a continuous manner (e.g., based on a clock signal) to execute instructions associated with an environment 210 and/or one or more programs associated with the synchronous event processing component 220. Thus, synchronous event processing component 220 executes instructions one step at a time at each clock cycle independent of the presence or absence of input from the environment 210. For example, even when no input is available from the environment 210, synchronous event processing component 220 is in some cases configured to nonetheless remain active via idle commands or input requests until new input is received.

Similarly, asynchronous event processing component 240 as shown in block diagram 202 can be configured to perform actions in response to inputs from an environment 210 (via an event manager 230). However, in contrast to the synchronous system shown in block diagram 200, asynchronous event processing component 240 is configured to rest or otherwise deactivate when no input events are present. Further, event manager 230 can be configured to control the amount and/or rate of events that are provided to asynchronous event processing component 240 via scheduling or other means, thereby enabling event manager 230 to finely control the activity level of asynchronous event processing component 240 and, as a consequence, the rate at which asynchronous event processing component 240 utilizes resources such as memory, power, or the like. In an embodiment, event manager 230 can be implemented by an entity (e.g., an operating system, etc.) that is independent of program(s) associated with asynchronous event processing component 240 and an input stream associated with the environment 210, which enables event manager 230 to operate transparently to both the environment 210 and the asynchronous event processing component 240. In turn, this enables resource optimization to be achieved for a given program with less focus on resource optimization during creation of the program, thereby expediting programming and related processes.

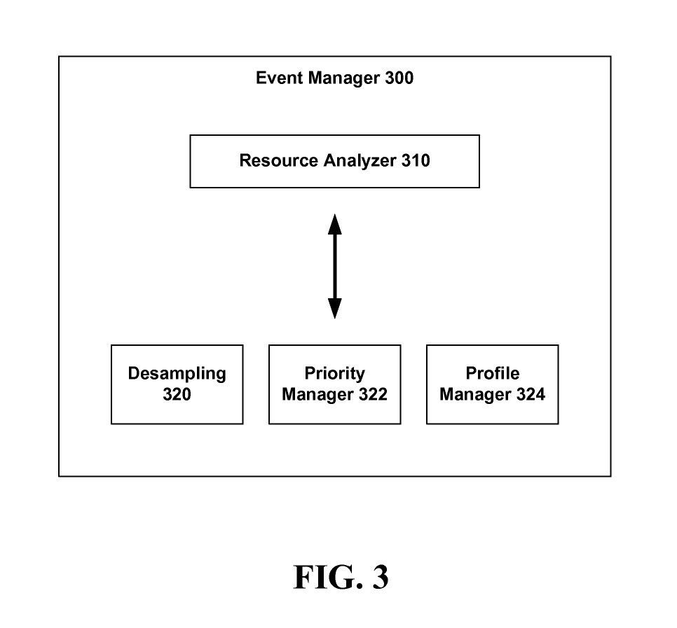

Illustrating one or more additional aspects, FIG. 3 is a block diagram showing an event manager component 300 containing a resource analyzer component 310 and respective other components 320-324 for managing events associated with an environment event stream as generally described herein. In one embodiment, upon intercepting and/or otherwise collecting a set of events from an event stream, event manager component 300 can utilize resource analyzer component 310 to compute or otherwise identify a desired level of resource usage (e.g., work level, power level, etc.) to be utilized by one or more entities responsible for processing of the set of events. For example, resource analyzer component 310 can estimate or otherwise determine levels of resource usage associated with respective events, based on which event manager component 300 modulates the amount of events that are passed to other entities for further processing.

In an embodiment, event manager component 300 serves as an input regulator by controlling the speed and/or amount of work that is performed by event processing entities. As a result, event manager component 300 can ultimately control the amount of resource usage (e.g., power usage, etc.) that is utilized by its associated computing system. In one example, event manager component 300 can be implemented independently of application development, e.g., as part of an operating system and/or other means.

Further, event manager component 300 can operate upon respective received events in order to facilitate consistency of the events and/or to facilitate handling of the events in other suitable manners. For example, event manager component 300 can intercept events that arrive at an irregular rate and buffer and/or otherwise process the events in order to provide the events to one or more processing nodes at a smoother input rate. In another example, event manager component 300 can facilitate grouping of multiple events into an event burst and/or other suitable structure, which can in some cases enable expedited processing of the events of the burst (e.g., due to commonality between the events and/or other factors). Additionally or alternatively, event manager component 300 can aggregate respective events and perform one or more batch pre-processing operations on the events prior to passing the events to a processing node.

As further shown in FIG. 3, resource analyzer component 310 can interact with various other components 320-324 to facilitate system workflow control as described herein. These components can include, e.g., a desampling component 320, a priority manager component 322, and/or a profile manager component 324. In one example, desampling component 320 is utilized to remove one or more arriving events from an incoming event stream, thereby desampling the event stream prior to passing respective events of the event stream on to their responsible program(s). In an embodiment, desampling component 320 can be utilized by event manager component 300 as part of an overarching event time control scheme. More particularly, event manager component 300 operates with reference to an asynchronous, event-based computing system as noted above. Accordingly, event manager component 300, via desampling component 320 or the like, can decouple events of an incoming event stream from the time(s) and/or rate(s) at which they are received, allowing event manager component 300 to move, re-order, remove, shift, and/or perform any other suitable operations on respective events in time in order to maintain a desired resource usage level determined by resource analyzer component 310.

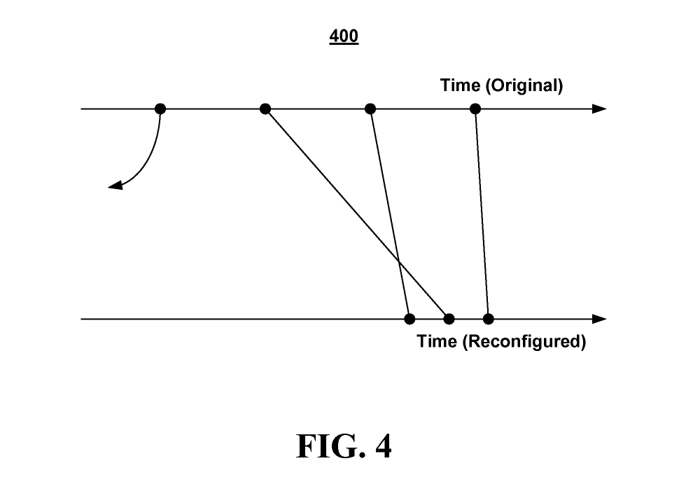

As an illustrative example of time shifting that can be performed with respect to a set of events, graph 400 in FIG. 4 illustrates a set of four incoming events and exemplary manners in which the incoming events can be reconfigured. As shown by graph 400, one or more events can be removed from the arriving stream (indicated on graph 400 by an outward arrow), and other events can be shifted in time, re-ordered, and/or processed in any other suitable manner.

With reference again to desampling component 320 in FIG. 3, removal of respective arriving events can be performed in various manners and according to any suitable criteria. In one example, desampling of an event stream can be conducted such that events are removed from the event stream upon expiration of a predetermined amount of time following instantiation of the event. Event desampling in this manner can be performed for, e.g., time-sensitive applications for which events become “stale” with time, such as stock monitoring applications, real-time communication applications, etc. In another example, desampled events can be directly discarded or effectively discarded through other means, such as by scheduling desampled events infinitely forward in time.

In another embodiment, a priority manager component 322 implemented by event manager component 300 prioritizes arriving events based on various factors prior to provisioning of the events to processing entities. In one example, prioritization of events can be based on properties of the events and/or applications associated with the events. By way of non-limiting example, a first application can be prioritized over a second application such that events of the second application are passed along for processing before events of the first application.

In one example, priorities utilized by priority manager component 322 are dynamic based on an operating state of the underlying system. As a non-limiting example, a mobile handset with global positioning system (GPS) capabilities can prioritize GPS update events with a higher priority than other events (e.g., media playback events, etc.) when the handset is determined to be moving and a lower priority than other events when the handset is stationary. In another specific example involving GPS events of a mobile handset, priority of GPS events can be adjusted with finer granularity depending on movement of the handset. Thus, GPS events can be given a high priority when a device moves at a high rate of speed (e.g., while a user of the device is traveling in a fast-moving vehicle, etc.) and lower priority when the device is stationary or moving at lower rates of speed (e.g., while a user of the device is walking, etc.).

In an additional example, priority information is at least partially exposed to a user of the underlying system to enable the user to specify priority preferences for various events. In one embodiment, an interface can be provided to a user, through which the user can specify information with respect to the desired relative priorities of respective applications or classes of applications (e.g., media applications, e-mail and/or messaging applications, voice applications, etc.).

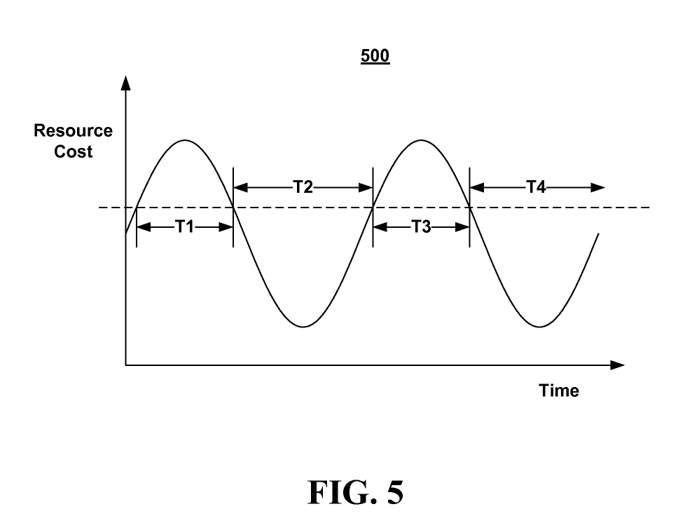

In another embodiment, event manager component 300 can, with the aid of or independently of priority manager component 322, regulate the flow of events to associated program(s) based on a consideration of resource costs according to various factors. For example, as shown in graph 500 in FIG. 5, resources (e.g., power, etc.) can in some cases be associated with a cost that varies with time. In turn, event manager component 300 can leverage this cost variation to optimize performance of the underlying computing system. It can be appreciated that while graph 500 illustrates an exemplary relationship between cost of a resource and time, graph 500 is provided for illustrative purposes only and is not intended to imply any specific relationship between any resource(s) and their cost variance, nor is graph 500 intended to imply the consideration of any specific resources in the determinations of event manager component 300.

In one example, varying resource costs such as those illustrated by graph 500 can be tracked by event manager component 300 in order to aid in scheduling determinations for respective events. For instance, graph 500 illustrates four time periods, denoted as T1 through T4, between which resource cost varies with relation to a predefined threshold cost. Accordingly, more events can be scheduled for time intervals in which resource cost is determined to be below the threshold, as shown at times T2 and T4. Conversely, when resource cost is determined to be above the threshold, as shown by times T1 and T3, less events are scheduled (e.g., via input buffering, rate reduction, queuing of events for release at a less costly time interval, etc.). While graph 500 illustrates considerations with relation to a single threshold, it can be appreciated that any number of thresholds can be utilized in a resource cost determination. Further, thresholds need not be static and can alternatively be dynamically adjusted based on changing operating characteristics and/or other factors.

By way a non-limiting implementation example of the above, the battery charge level of a battery-operated computing device can be considered in a resource cost analysis. For instance, due to the fact that a battery-operated device has more available power when its battery is highly charged or the device is plugged into a secondary power source, the cost of power associated with such a device can be regarded as less costly than the cost of power associated with the device when its battery is less charged. Accordingly, the amount of inputs processed by the device can be increased by event manager component 300 when the device is highly charged and lowered when the device is less charged.

As another implementation example, factors relating to varying monetary costs associated with cooling a computing system, such as changes in ambient temperature, monetary per-unit rates of power, or the like, can be considered in a similar manner to the above. As a further example, the cost of resources can increase as their use increases. For instance, a mobile handset operating in an area with weak radio signals, a large number of radio collisions, or the like may utilize power via its radio subsystem at a relatively high rate. In such a case, the number of radio events and/or other events can be reduced to optimize the resource usage of the device.

In a further embodiment illustrated by FIG. 3, event manager component 300 includes a profile manager component 324 that facilitates management of an event stream in relation to a global resource profile. In conventional computing systems, it can be appreciated that resource profiles are generally implemented in a low-level manner. For example, in the case of power profiles, respective components are affected in isolation (e.g., screen dimming/shutoff, graphics controller power reduction, processor clock reduction, and/or other operations after a predetermined amount of time). In contrast, profile manager component 324 enables the use of global power profiles and/or other resource profiles, which can be utilized to control the resource usage of a computing system in a more general manner. In a further example, power profiles leveraged by profile manager component 324 can be dynamic based on a feedback loop from the underlying computer system and/or other means.

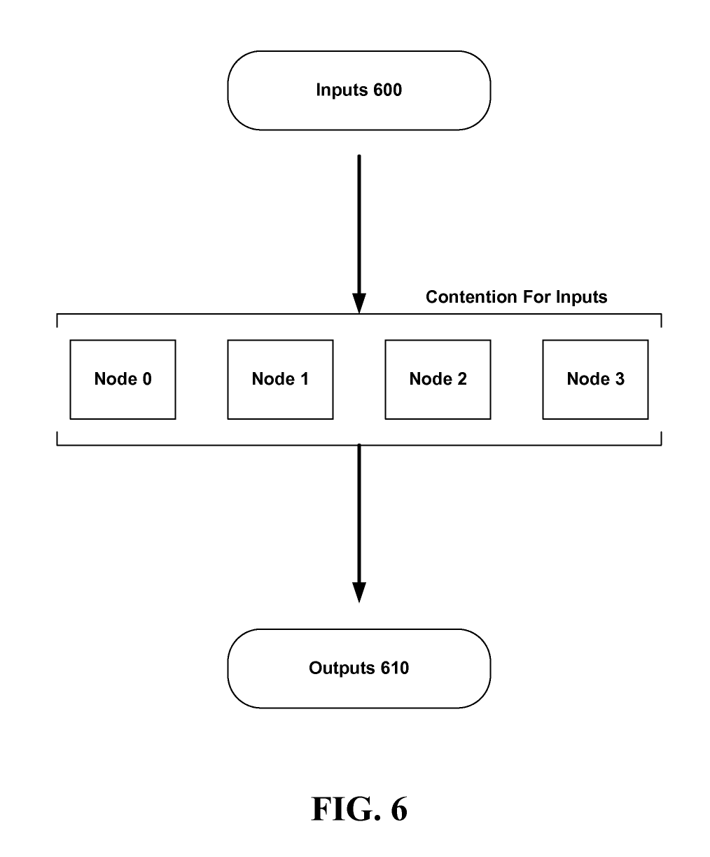

In other embodiments, event management as described herein can be utilized to optimize performance across a set of event processing nodes (e.g., processors, processor cores, machines in a distributed system, etc.). For instance, as illustrated by FIG. 6, if respective nodes operate in a conventional manner by requesting inputs 600 from a program environment and producing outputs 610 based on the requested inputs, respective nodes may operate without knowledge of the other nodes and/or applications running on other nodes. As a result of this lack of cross-communication between nodes and applications running thereon in a conventional system, requests made by the respective nodes for inputs 600 can in some cases result in contention for those inputs 600, which can lead to a reduction in system efficiency, an increase in resource usage, and/or other negative characteristics.

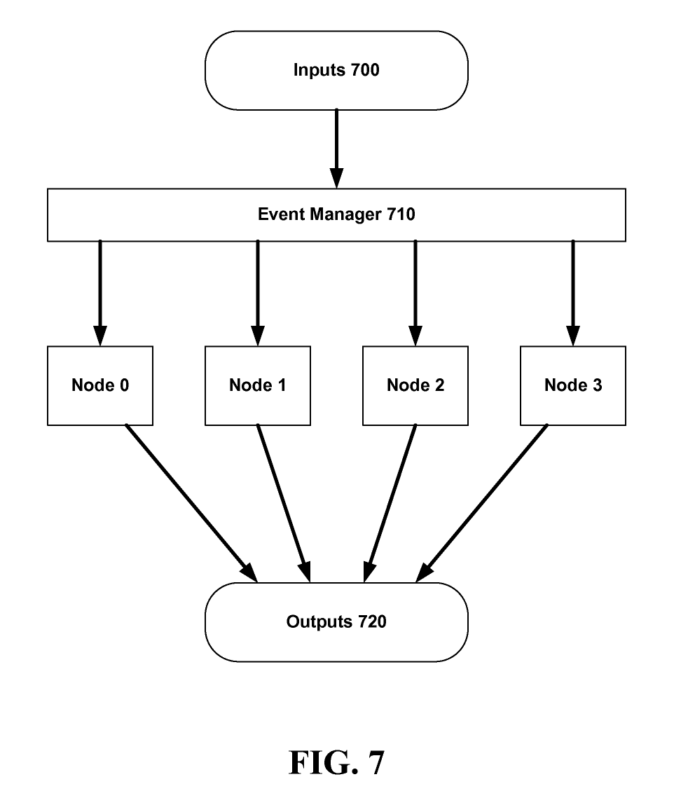

In contrast, as shown in FIG. 7, an event manager component 710 can be utilized as an intermediary between inputs 700 and the respective processing nodes in order to distribute the inputs among the respective nodes, thereby enabling the nodes to process the inputs 700 and create corresponding outputs 720 with substantially increased efficiency. In an embodiment, a loading scheme determined by event manager component 710 can distribute inputs 700 among a set of nodes in any suitable manner. For example, loading among nodes can be substantially balanced, or alternatively a non-uniform distribution can be utilized to account for differences in capability of the respective nodes and/or other factors. In another example, a load distribution utilized by event manager component 710 can be dynamically adjusted according to various factors. By way of non-limiting example, a battery-operated computing device with multiple processor cores can be configured by event manager component 710 such that one or more cores are inactivated when the battery level of the device is low. Accordingly, even manager component 710 can take resource cost considerations as generally described above into account in its load distribution scheme. In another example, event manager component 710 can be configured to divert inputs 700 away from a malfunctioning, inoperable, and/or otherwise undesirable processing node.

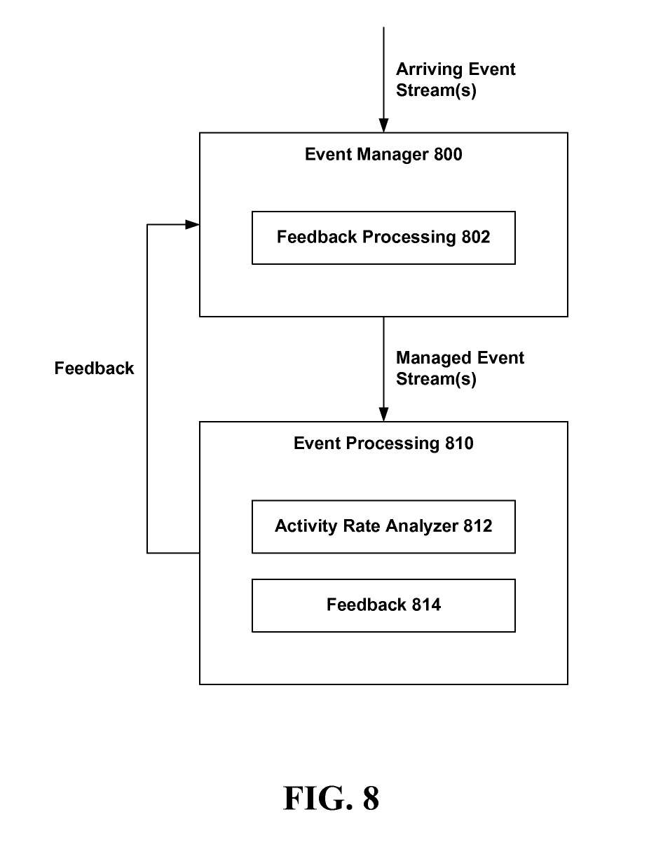

With reference next to FIG. 8, a block diagram is provided that illustrates exemplary interaction between an event manager component 800 and an event processing component 810. As shown in FIG. 8, event processing component 810 tracks its activity level via an activity rate analyzer component 812. Subsequently, event processing component 810 can feed back information relating to its activity level and/or any other suitable information to event manager component 800 via a feedback component 814. In response to feedback information received from event processing component 810, event manager component 800 can adjust the work rate assigned to event processing component 810 and/or other aspects of the events provided to event processing component 810.

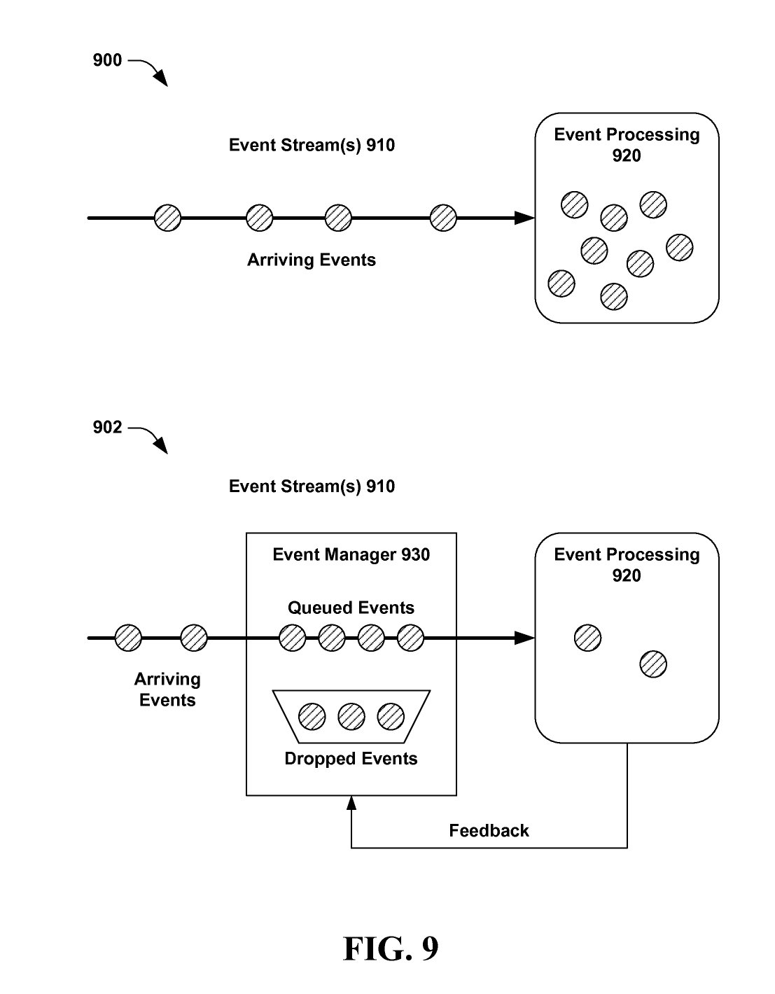

With further regard to the above embodiments, FIG. 9 provides an illustrative overview of respective operations that can be performed by an event manager component 930 in relation to one or more event streams 910. In an embodiment, event manager component 930 operates to reduce the costs associated with processing respective events arriving on event stream(s) 910. Accordingly, in contrast to maintaining an unfiltered event stream to an event processing component as shown in block diagram 900, thereby resulting in a highly stressed system that utilizes a large amount of resources, the number of events that are processed by event processing component 920 can be regulated by event manager component 930 as shown in block diagram 902.

In one example, the system shown by block diagram 902 utilizes a feedback loop to facilitate adjustment of the rate of input to event processing component 920. For instance, in the event that the desired workload of event processing component 920 changes, the feedback loop to event manager component 930 adjusts the incoming rate to match the desired workload using one or more mechanisms. In an embodiment, these mechanisms can be influenced by profiles and/or other means, which can allow different strategies based on the time of day and/or other external factors.

When an application is structured in an event-driven style as shown by FIG. 9, it can be appreciated that it is less burdensome to implement workload regulation mechanisms such as those described herein than in traditional systems. In one embodiment, the throttling mechanisms utilized by event manager component 930 can be made transparent to the actual logic of the application(s) running at event processing component 920.

In an embodiment, respective throttling mechanisms can be encapsulated as a stream processor (e.g., implemented via event manager component 930 and/or other means) that takes a variety of inputs representing, amongst others, the original input stream, notifications from the feedback loop, and profile and rule-based input to produce a modified event stream that can be fed into the original system (e.g., corresponding to event processing component 920). In one example, the level of compositionality provided by the techniques provided herein enables the use of different strategies for different event streams. By way of non-limiting example, GPS sampling rate and accuracy, accelerometer sampling rate, radio output strength, and/or other aspects of device operation can be decreased when power levels are relatively low.

In another example, throttling can be achieved via generation of new events based on a certain threshold. In the specific, non-limiting example of a GPS receiver, by increasing the movement threshold (and hence decreasing the resolution), the amount of events can be significantly reduced. For instance, by changing from a GPS threshold of 10 meters to a threshold of 100 meters, savings of a factor of 10 are achieved. In an embodiment, a user of a GPS receiver and/or any other device that receives GPS signals that can be utilized as described herein can be provided with various mechanisms by which the user can provide consent for, and/or opt out of, the use of the received GPS signals for the purposes described herein.

In a further embodiment, event manager component 930 can leverage a queue data structure and/or other suitable data structures to maintain events associated with event stream 910 in an order in which the events arrive. Additionally or alternatively, other structures, such as a priority queue, can be utilized to maintain priorities of the respective events. Accordingly, event manager component 930 can utilize, e.g., a first queue for representing events as they are received, which can in turn be transformed into a second queue for representing the events as they are to be delivered. In one example, event manager component 930 can be aware of the source(s) of respective arriving events and can utilize this information in its operation. Information identifying the source of an arriving event can be found, e.g., within the data corresponding to the event. For instance, a mouse input event can provide a time of the event, a keyboard input event can provide a time of the event and the identity of the key(s) that has been pressed, and so on.

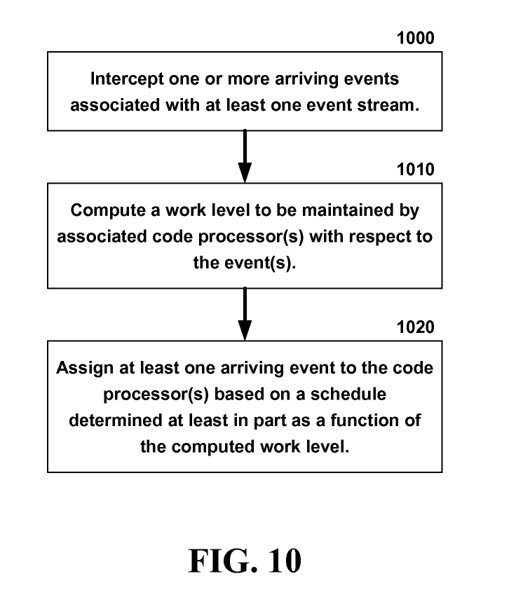

FIG. 10 is a flow diagram illustrating an exemplary non-limiting process for managing an event-based computing system. At 1000, one or more events associated with at least one event stream are intercepted. At 1010, a work level to be maintained by associated code processor(s) with respect to the event(s) intercepted at 1000 is computed. At 1020, at least one of the arriving events intercepted at 1000 is assigned to the code processor(s) based on a schedule determined at least in part as a function of the work level computed at 1010.

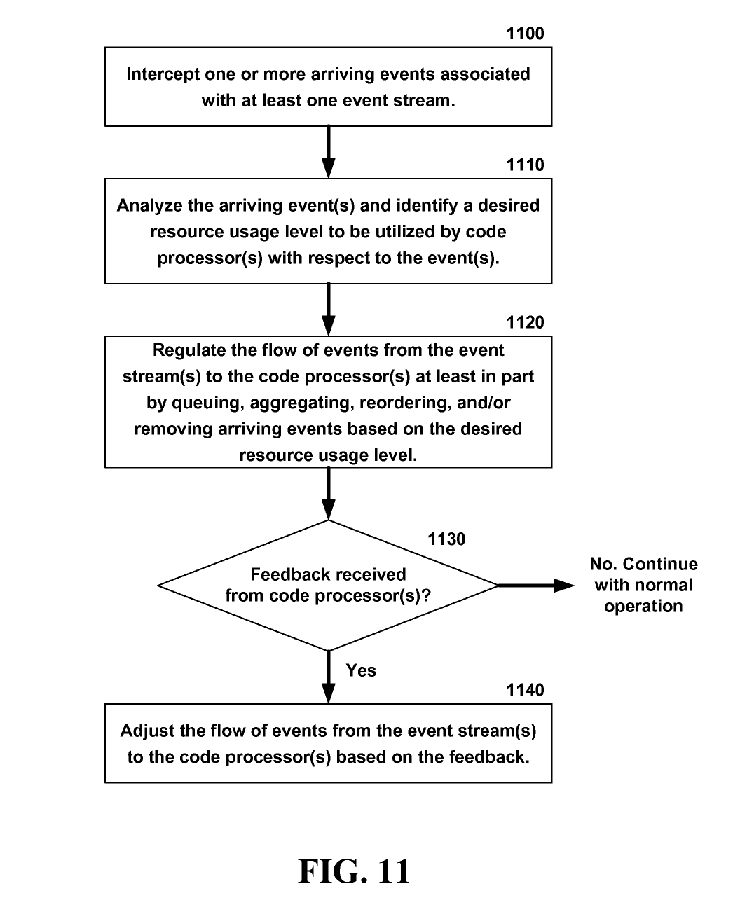

FIG. 11 is a flow diagram illustrating an exemplary non-limiting process for regulating the flow of activity to one or more processing nodes. At 1100, one or more arriving events associated with at least one event stream are intercepted. At 1110, the arriving event(s) intercepted at 1100 are analyzed, and a desired resource usage level (e.g., a power level, etc.) to be utilized by code processor(s) with respect to the event(s) is identified. At 1120, the flow of events from the event stream(s) to the code processor(s) is regulated at least in part by queuing, aggregating, reordering, and/or removing arriving events based on the desired resource usage level identified at 1110. At 1130, it is then determined whether feedback has been received from the code processor(s). If not, normal operation is continued. Otherwise, at 1140, the flow of events from the event stream(s) to the code processor(s) is adjusted based on the received feedback.

### Exemplary Networked and Distributed Environments

One of ordinary skill in the art can appreciate that the various embodiments of the event management systems and methods described herein can be implemented in connection with any computer or other client or server device, which can be deployed as part of a computer network or in a distributed computing environment, and can be connected to any kind of data store where snapshots can be made. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

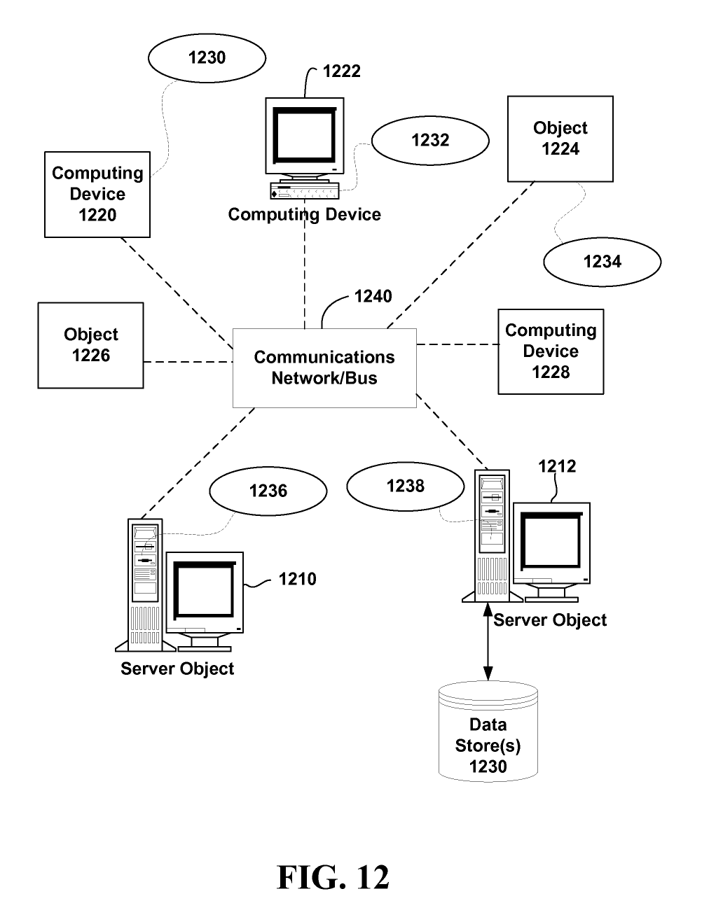

FIG. 12 provides a schematic diagram of an exemplary networked or distributed computing environment. The distributed computing environment comprises computing objects 1210, 1212, etc. and computing objects or devices 1220, 1222, 1224, 1226, 1228, etc., which may include programs, methods, data stores, programmable logic, etc., as represented by applications 1230, 1232, 1234, 1236, 1238. It can be appreciated that computing objects 1210, 1212, etc. and computing objects or devices 1220, 1222, 1224, 1226, 1228, etc. may comprise different devices, such as personal digital assistants (PDAs), audio/video devices, mobile phones, MP3 players, personal computers, laptops, etc.

Each computing object 1210, 1212, etc. and computing objects or devices 1220, 1222, 1224, 1226, 1228, etc. can communicate with one or more other computing objects 1210, 1212, etc. and computing objects or devices 1220, 1222, 1224, 1226, 1228, etc. by way of the communications network 1240, either directly or indirectly. Even though illustrated as a single element in FIG. 12, communications network 1240 may comprise other computing objects and computing devices that provide services to the system of FIG. 12, and/or may represent multiple interconnected networks, which are not shown. Each computing object 1210, 1212, etc. or computing object or device 1220, 1222, 1224, 1226, 1228, etc. can also contain an application, such as applications 1230, 1232, 1234, 1236, 1238, that might make use of an API, or other object, software, firmware and/or hardware, suitable for communication with or implementation of the event management techniques provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the event management systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 12, as a non-limiting example, computing objects or devices 1220, 1222, 1224, 1226, 1228, etc. can be thought of as clients and computing objects 1210, 1212, etc. can be thought of as servers where computing objects 1210, 1212, etc., acting as servers provide data services, such as receiving data from client computing objects or devices 1220, 1222, 1224, 1226, 1228, etc., storing of data, processing of data, transmitting data to client computing objects or devices 1220, 1222, 1224, 1226, 1228, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1240 or bus is the Internet, for example, the computing objects 1210, 1212, etc. can be Web servers with which other computing objects or devices 1220, 1222, 1224, 1226, 1228, etc. communicate via any of a number of known protocols, such as the hypertext transfer protocol (HTTP). Computing objects 1210, 1212, etc. acting as servers may also serve as clients, e.g., computing objects or devices 1220, 1222, 1224, 1226, 1228, etc., as may be characteristic of a distributed computing environment.

### Exemplary Computing Device

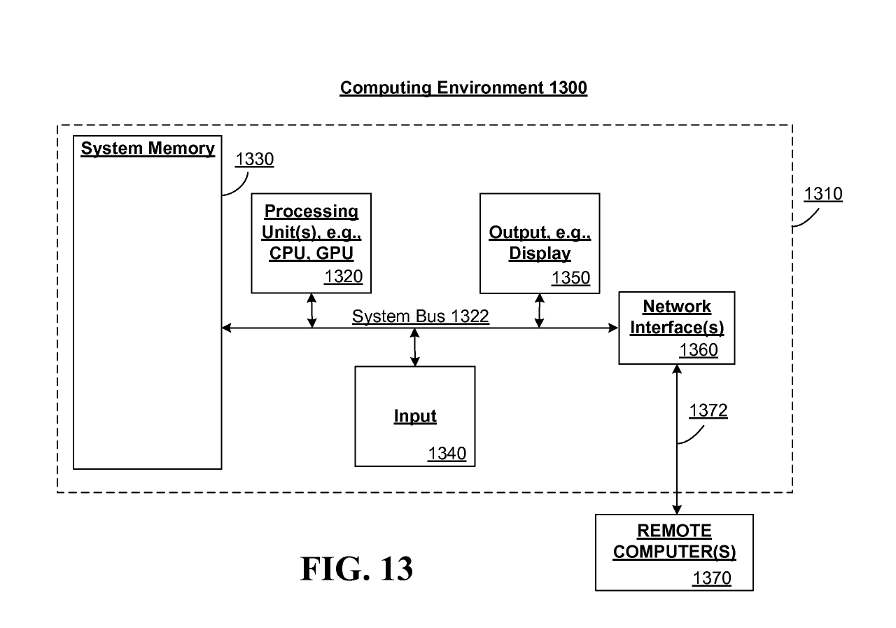

As mentioned, advantageously, the techniques described herein can be applied to any device where it is desirable to perform event management in a computing system. It can be understood, therefore, that handheld, portable and other computing devices and computing objects of all kinds are contemplated for use in connection with the various embodiments, i.e., anywhere that resource usage of a device may be desirably optimized. Accordingly, the below general purpose remote computer described below in FIG. 13 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 13 thus illustrates an example of a suitable computing system environment 1300 in which one or aspects of the embodiments described herein can be implemented, although as made clear above, the computing system environment 1300 is only one example of a suitable computing environment and is not intended to suggest any limitation as to scope of use or functionality. Neither should the computing system environment 1300 be interpreted as having any dependency or requirement relating to any one or combination of components illustrated in the exemplary computing system environment 1300.

With reference to FIG. 13, an exemplary remote device for implementing one or more embodiments includes a general purpose computing device in the form of a computer 1310. Components of computer 1310 may include, but are not limited to, a processing unit 1320, a system memory 1330, and a system bus 1322 that couples various system components including the system memory to the processing unit 1320.

Computer 1310 typically includes a variety of computer readable media and can be any available media that can be accessed by computer 1310. The system memory 1330 may include computer storage media in the form of volatile and/or nonvolatile memory such as read only memory (ROM) and/or random access memory (RAM). By way of example, and not limitation, system memory 1330 may also include an operating system, application programs, other program modules, and program data.

A user can enter commands and information into the computer 1310 through input devices 1340. A monitor or other type of display device is also connected to the system bus 1322 via an interface, such as output interface 1350. In addition to a monitor, computers can also include other peripheral output devices such as speakers and a printer, which may be connected through output interface 1350.

The computer 1310 may operate in a networked or distributed environment using logical connections to one or more other remote computers, such as remote computer 1370. The remote computer 1370 may be a personal computer, a server, a router, a network PC, a peer device or other common network node, or any other remote media consumption or transmission device, and may include any or all of the elements described above relative to the computer 1310. The logical connections depicted in FIG. 13 include a network 1372, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A computing event management system, comprising:
an event manager component configured to receive one or more events via at least one event stream associated with an environment; and
a resource analyzer component configured to compute a target resource usage level to be utilized by at least one event processing node for respective events of the one or more events; and
wherein the event manager component provides at least one event of the one or more events to the at least one event processing node in an order and at a rate determined according to the target resource usage level.

2. The system according to claim 1, wherein the target resource usage level comprises a power level.

3. The system according to claim 1, wherein the resource analyzer component is further configured to identify information relating to resource costs and the event manager component is further configured to provide the at least one event of the one or more events to the at least one event processing node based at least in part on the resource costs.

4. The system according to claim 1, further comprising:
a desampling component configured to generate one or more desampled event streams at least in part by removing at least one event of the one or more events;
wherein the event manager component provides the at least one event of the one or more desampled event streams to the at least one event processing node.

5. The system according to claim 4, wherein the desampling component is further configured to remove respective events of the one or more events based at least in part on elapsed time from instantiation of the respective events.

6. The system according to claim 1, wherein the event manager component is further configured to provide a burst of at least two events to the at least one event processing node.

7. The system according to claim 1, wherein the event manager component is further configured to distribute the at least one event of the one or more events among a set of event processing nodes.

8. The system according to claim 1, further comprising:
a feedback processing component configured to receive activity level feedback from the at least one event processing node and to control the rate at which events are provided to the at least one event processing node based at least in part on the activity level feedback.

9. The system according to claim 1, further comprising:
a priority manager component configured to identify priorities of respective events of the one or more events;
wherein the event manager component provides at least one event of the one or more events to the at least one event processing node according to the priorities of the respective events of the one or more events.

10. The system according to claim 9, wherein the priority manager component is further configured to obtain at least one of user-specified information relating to priorities of the respective events of the one or more events or user-specified information relating to priorities of respective event streams of the at least one event stream.

11. The system according to claim 9, wherein the priority manager component is further configured to dynamically configure the priorities of the respective events of the one or more events based at least in part on an operating state of the at least one event processing node.

12. The system according to claim 1, wherein the event manager component is further configured to identify a set of events received via the at least one event stream at an irregular rate and to provide the set of events to the at least one event processing node at a uniform rate.

13. The system according to claim 1, wherein the event manager component is further configured to aggregate respective events received via the at least one event stream.

14. The system according to claim 1, further comprising:
a profile manager component configured to maintain information relating to a resource usage profile of the at least one event processing node;
wherein the event manager component provides at least one event of the one or more events to the at least one event processing node according to the resource usage profile of the at least one event processing node.

15. A method for coordinating an event-driven computing system, comprising:
receiving one or more events associated with at least one event stream;
identifying a work level to be maintained by at least one event processor with respect to the one or more events; and
assigning at least one event of the one or more events to the at least one event processor based on a schedule determined at least in part as a function of the work level to be maintained by the at least one event processor.

16. The method of claim 15, wherein the identifying comprises identifying a power level to be maintained by the at least one event processor with respect to the one or more events.

17. The method of claim 15, wherein the assigning comprises electing not to assign at least one event of the one or more events to the at least one event processor.

18. The method of claim 15, wherein the assigning comprises assigning respective events of the one or more events in a distributed manner across a plurality of event processors.

19. The method of claim 15, further comprising:
receiving feedback relating to activity levels of the at least one event processor;
wherein the assigning comprises assigning the at least one event of the one or more events based at least in part on the feedback.

20. A system that facilitates coordination and management of computing events, comprising:
means for identifying information relating to one or more streams of computing events;
means for determining a resource usage level to be utilized by at least one event processing node in handling respective events of the one or more streams of computing events; and
means for assigning at least one computing event of the one or more streams of computing events to the at least one event processing node based at least in part on the resource usage level determined by the means for determining.
